(19) United States
(12) Patent Application Publication
(10) Pub. No.: US 2007/0048112 A1
(43) Pub. Date: Mar. 1, 2007

(54) Shelf assembly

(75) Inventors: John Andersen, Fredrikstad (NO); Hakan Sjolander, Bracke (SE)

Correspondence Address: BIRCH STEWART KOLASCH & BIRCH, PO BOX 747, FALLS CHURCH, VA, 22040-0747, US

(73) Assignee: ENJOY GROUP AB, Bracke (SE)

(21) Appl. No.: 11/448,814

(22) Filed: Jun. 8, 2006

(30) Foreign Application Priority Data
Jun. 15, 2005 (EP) 05105277.7

(51) Int. Cl. B62D 43/00

(52) U.S. Cl. 414/466

(57) ABSTRACT

A self-contained in-store merchandise shelf assembly has a shelf carriage supporting a plurality of shelves, and a guide arrangement cooperating with the shelf carriage. The shelf assembly is movably arranged between a display position, where the shelves are accessible from a front side of the shelf carriage, a refill position, where the shelves are accessible from a rear side of the shelf carriage, and an intermediate position. The shelf carriage is arranged for linear translation between the display position and the intermediate position, and for turning motion between the intermediate position and the refill position. The guide arrangement includes a turning guide adapted to guide the turning motion of the shelf carriage between the intermediate position and the refill position.

### TECHNICAL FIELD OF THE INVENTION

The invention relates to a self-contained in-store merchandise shelf assembly, comprising a shelf carriage supporting a plurality of shelves and being movably arranged between a display position, where the shelves are accessible from a front side of the shelf carriage, a refill position, where the shelves are accessible from a rear side of the shelf carriage, and an intermediate position.

### BACKGROUND ART

In stores, shelf carriages are typically used for storing and displaying items of merchandise to the customers. A shelf carriage is a movable rack supporting a plurality of shelves. In some stores a considerable part of the displayed merchandise have expiry dates, for example edible products displayed in food stores or batteries displayed in filling stations. When displaying such merchandise, it is desirable to have the oldest items at the front of the shelves, thereby making the oldest items sell first and lowering the risk that items are sold after their expiry dates. When the shelf carriage is to be filled with new items, it is therefore desirable to fill the new items from the back of the shelves.

Normally the shelf carriages are arranged side by side along isles or against a wall in the store. Since a shelf carriage is obstructed by the adjacent carriages, it is usually not possible to just turn the shelf carriage around for accessing the rear side thereof. It is necessary to move the shelf carriage. Since the space available therefore in an isle usually is limited and the shelf carriages with the displayed merchandise often have a considerable weight, this is a difficult and heavy operation for a shop attendant. In addition, after having loaded the shelf carriage, it is tricky and heavy to align the heavy shelf carriage again for moving it back to its original position between the other shelves in the store.

US 2002/0060198 A1 discloses a product display and dispensing system comprising a gondola display. In one row of shelves, the shelves are hingedly attached to the gondola display, thereby allowing the shelves to be rotated away from the gondola. Thus, the rear of the shelves are exposed such that they can be refilled. A problem with this known system is that the space between the rotated shelf and the adjacent shelves is narrow, rendering refilling operations inconvenient and time consuming. Furthermore, the system according to US 2002/0060198 A1 is a complex structure which is costly to install.

### SUMMARY OF THE INVENTION

It is therefore an object of the present invention to provide a shelf assembly and a shelving system comprising such shelf assemblies, which alleviates the above-mentioned problems.

According to the invention, this object is achieved by the self-contained in-store merchandise shelf assembly according, which comprises a shelf carriage supporting a plurality of shelves and being movably arranged between a display position, where the shelves are accessible from a front side of the shelf carriage, a refill position, where the shelves are accessible from a rear side of the shelf carriage, and an intermediate position. The shelf assembly further comprises a guide arrangement cooperating with the shelf carriage. The shelf carriage is arranged for linear translation between the display position and the intermediate position and for turning motion between the intermediate position and the refill position. The guide arrangement includes a turning guide adapted to guide the turning motion of the shelf carriage between the intermediate position and the refill position.

Usually it is fairly easy to pull a shelf carriage back and forth along an approximately linear path. In the prior art, it has proven to be the turning motion or the combined turning and translation motion of a shelf carriage for accessing the rear side thereof, that displaces the shelf carriage in such a way that it is difficult to find the position where the shelf carriage is aligned for being pushed back to the display position.

Thus, the shelf carriage according to the invention is arranged for a linear translation followed by a turning motion when the shelf carriage is moved from the display position to the refill position, wherein the turning motion is guided. Thereby it is possible to linearly pull the shelf carriage free of any adjacent shelves or obstacles to an intermediate position. In this position turning of the shelf carriage is enabled while at the same time the shelf carriage is correctly aligned for the translation to or from the display position. From the intermediate position, the shelf carriage can be turned a suitable angle such that unrestricted access to the rear side of the shelves are achieved. Due to the turning motion being guided, it is easy to return the shelf carriage to the intermediate position after the shelves have been refilled. Since the shelf carriage is correctly aligned in the intermediate position, the shelf carriage can easily be pushed back to the display position.

The invention relates to a shelf assembly intended to be arranged on a shop floor or the like. It is a self-contained unit that can be arranged both individually and together with other shelf assemblies.

By “shelf carriage” is meant a movable rack having a plurality of shelves. In the rack, the shelves can be arranged sloping such that the items stored on the shelves, after an item has been removed, will slide forwards towards the costumer in the display position. In the refill position, the empty space on the shelves will face the refilling shop attendant. The shelves can also be provided with pushers for pushing the displayed items towards the front side of the shelf carriage.

The shelf carriages normally have an essentially rectangular cross section. This is also one reason for way they cannot be turned without first being pulled away from any adjacent shelf carriages or other display arrangements. According to the invention, the shelf carriage can of course have any other cross section.

The shelf carriage can be provided with wheels or a low friction surface for facilitating movement thereof.

By “display position” is meant the ordinary position wherein the goods are displayed and sold. By “refill position” is meant a position wherein the shelf carriage is refilled from the rear side.

According to the invention, the shelf assembly comprises a guide arrangement including a turning guide. The turning guide can be permanently connected to the shelf carriage or only during the turning motion between the intermediate position and the refill position. It may be sufficient that the turning guide abuts against the shelf carriage for guiding it during tuning.

The guide arrangement can be mounted on a shop floor, a shop wall or the like, or on an adjacent shelf rack. It is also possible to mount the guide on a separate detail.

According to the invention, the turning guide can be arranged to guide the shelf carriage in a curved or semicircular path, or to rotate around an axis. The axis of rotation can be a peripheral axis or a central axis of the shelf carriage.

According to one embodiment of the invention, the turning guide is connected with the shelf carriage in all the positions of the shelf carriage. In other embodiments, the turning guide acts on the shelf carriage only during the turning motion.

According to one embodiment of the present invention, the guide arrangement includes a translation guide. Due to the translation guide, also the linear translation of the shelf carriage is guided. Due to the translation guide, the intermediate position, in which the shelf carriage is correctly aligned for being moved back to the display position, is more exactly defined. Thereby, the shelf carriage is more easily retuned to the display position after refilling.

According to one embodiment of the invention, the linear translation of the shelf carriage takes place along a path extending in a normal direction to the front side of the shelf carriage. In other words, the shelf carriage is pulled or pushed forward or backwards. Any translation guide is consequently arranged in this direction.

According to one embodiment of the invention, the translation guide is adapted to act on the shelf carriage in all positions thereof. In other embodiments, the translation guide only acts on the shelf carriage during the linear translation.

According to one embodiment, the translation guide includes a linear rail being fixedly arranged in relation to the shelf carriage.

According to one embodiment the shelf assembly includes a guide plate which carries and supports the shelf carriage. The shelf carriage is rotatably connected with the guide plate such that the rotation of the shelf carriage is defined and guided by the guide plate. Furthermore, the translation guide is arranged to act on the guide plate. Consequently, the shelf carriage is linearly translated together with the guide plate when it is moved between the display position and the intermediate position, and rotated relative the guide plate when it is moved between the intermediate position and the refill position.

According to the invention several shelf assemblies can be placed side by side to make up a shelving system. In such a system the shelf assemblies can be interconnected.

### BRIEF DESCRIPTION OF THE DRAWINGS

In the following, the embodiments of the invention will be described in detail with reference to the enclosed drawings, in which:

FIG. 1 is a perspective view of two shelf assemblies according to the invention arranged side by side on a shop floor;

FIG. 2 is a schematic, exploded view of a first embodiment of a shelf assembly according to the invention;

FIG. 3 is a side view showing a linear translation of a shelf carriage according to the first embodiment of the invention between a display position and an intermediate position;

FIG. 4 is a view from above showing the turning motion of the shelf carriage according to the first embodiment of the invention between the intermediate position and a refill position;

FIG. 5 is a schematic view of a different turning guide according to the invention;

FIG. 6 is a schematic view of a different translation guide according to the invention;

FIG. 7 is a schematic view of locking means according to the invention; and

FIG. 8 is a perspective view of a another embodiment of a shelf assembly according to the invention;

### DETAILED DESCRIPTION OF EMBODIMENTS

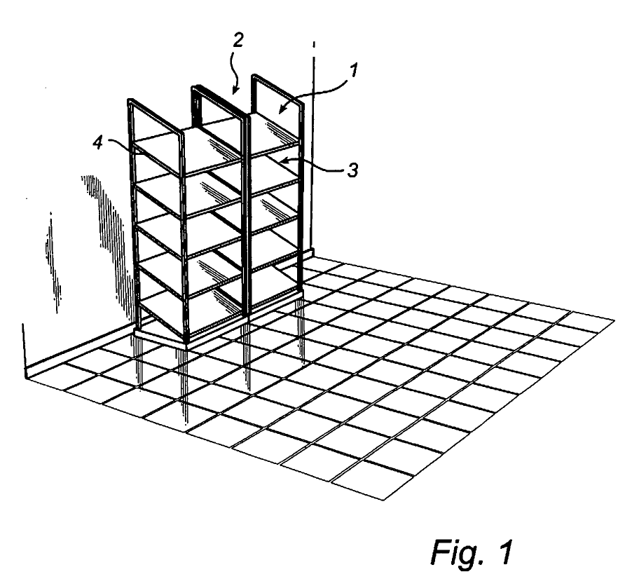

With reference to FIG. 1, two shelf assemblies according to the invention are shown. The shelf assemblies are arranged on a shop floor and are used for displaying items of merchandise. Each shelf assembly constitutes a separate, self-contained unit. Each shelf assembly includes a shelf carriage 1 supporting a plurality of sloping shelves 4. A rear side 2 of the shelf carriages 1 faces a shop wall and a front side 3 faces a shop isle. Any displayed items of merchandise on the shelves 4 are accessible for the consumers in the shown display position of the shelf carriage 1. Since the shelves 4 are sloping toward the isle in the display position, the items of merchandise will always be stacked beginning at the front side 3 and any empty space on the shelves will be located at the rear part of the shelves 4.

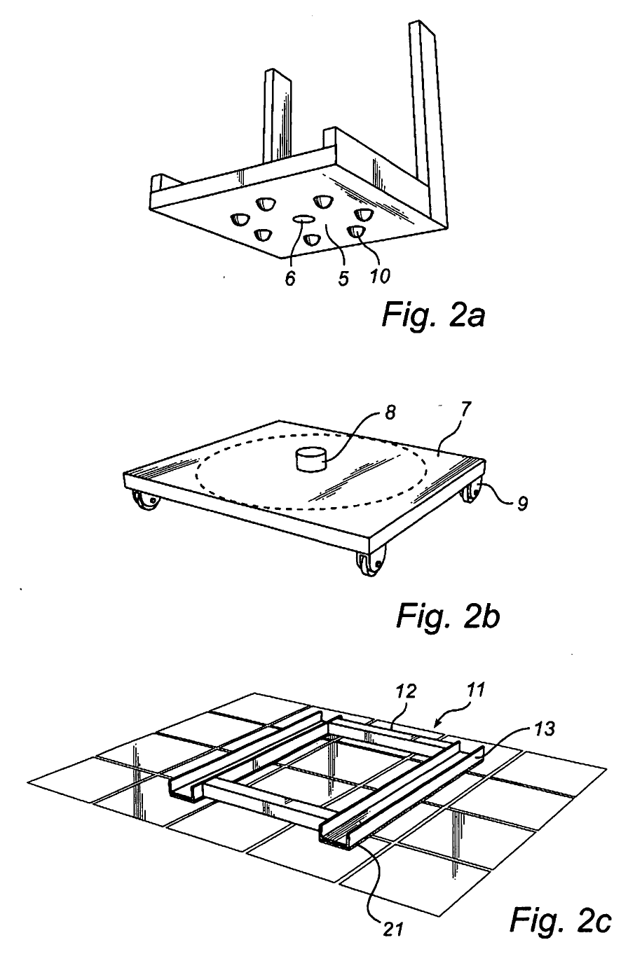

In FIG. 2 a first embodiment of the shelf assembly according to the invention is schematically shown in an exploded view. In FIG. 2, only the lower part of the shelf carriage 1 is shown and the shelves 4 thereof are not shown. The shelf carriage 1 has a rectangular bottom plate 5 provided with a circular bearing 6. The bottom plate 5 is furthermore provided with spherical balls 10 functioning as a bearing arrangement. An intermediate guide plate 7 is provided with a turning guide in form of a fixed axle 8 adapted to fit into the circular bearing 6. Furthermore, the guide plate 7 is provided with four wheels 9, one in each corner. A translation guide 11 includes two parallel U-shaped rails 13 interconnected by two cross bars 12. The rails 14 are secured to a shop floor by a frictional, elastic mat 21.

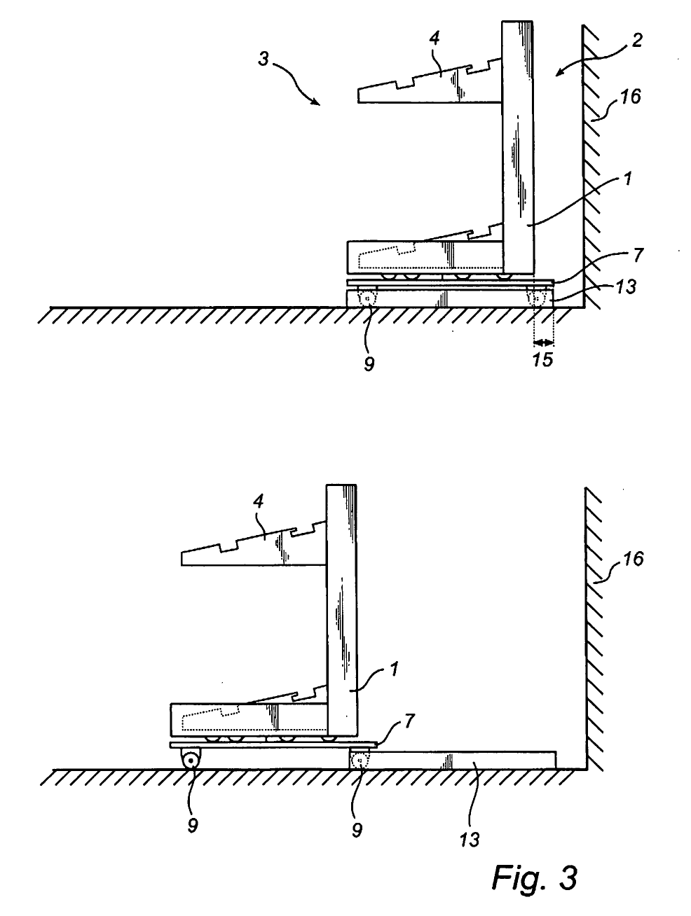

In the upper part of FIG. 3, an assembled shelf assembly is shown in a display position. The shelf carriage 1 is mounted on the guide plate 7 with the axle 8 received in the bearing 6. Thus, in this embodiment of the invention, the turning guide is connected with the shelf carriage in all positions thereof. The four wheels 9 of the shelf carriage are received between the flanges of the U-shaped rails 13, wherein two wheels 9 are received in each respective rail 13. In the display position the front side, a left and a right side of the shelf carriage 1 are aligned and interposed with the front edge, a left and a right edge of the guide plate 7. The rear, wall facing edge of the guide plate 7 protrudes a distance 15 behind the rear, wall facing side 2 of the shelf carriage 1.

The self-contained in-store merchandise shelf assembly according to the described embodiment functions in the following way.

When the shelf carriage is in the display position shown in the upper part of FIG. 3, consumers can easily pick items of merchandise from the front end of the sloping shelves. The rear side 2 of the shelf carriage faces a shop wall 16. When the stack of items on the shelves has decreased such that refilling of the shelves is needed, a shop attendant pulls the shelf carriage, together with the guide plate 7 carrying the shelf carriage, linearly away from the shop wall in a direction essentially normal to the shop wall 16. This linear translation of the shelf carriage is guided by the two rails 13, which force the wheels 9 of the guide plate 7 to roll between the flanges of the rails 13.

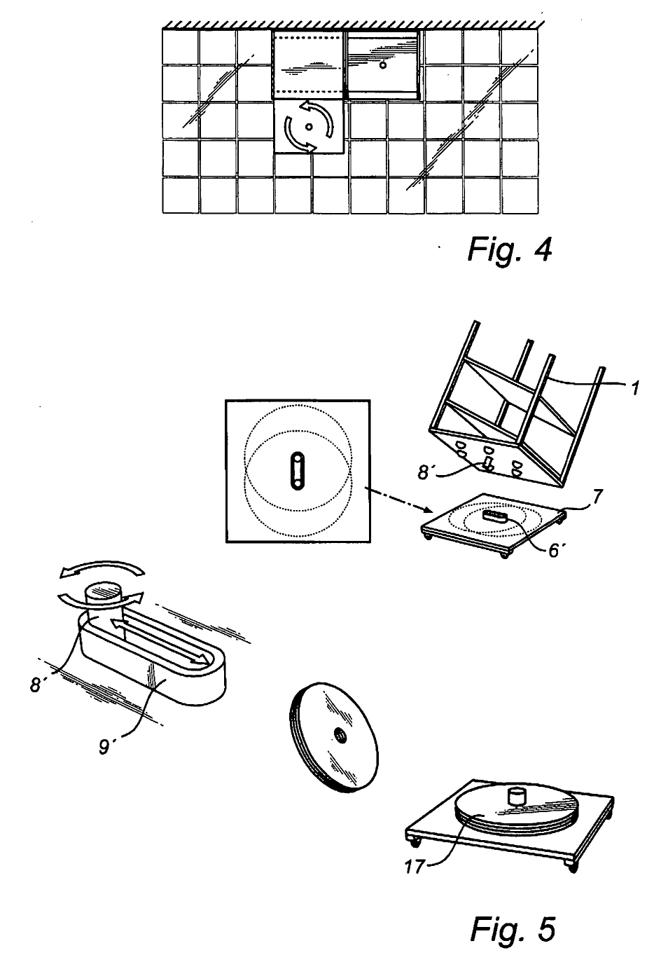

In the lower part of FIG. 3, the shelf carriage 1 is shown in the intermediate position. Due to the protruding portion 15 of the guide plate 7, the rear wheels 9 still have contact with the rails in the intermediate position, where the shelf carriage 1 has been pulled out a distance sufficiently long for allowing rotation of the shelf carriage 1 without being obstructed by adjacent shelf assemblies, cf. also FIG. 4. Consequently, the shop attendant can choose any suitable angle for accessing the rear side of the shelf carriage for refilling of the shelves from behind. When the shelf carriage is turned to the selected position for refilling, the turning motion thereof is guided by the axle 8 cooperating with the bearing 6. The turning motion is facilitated by the ball bearings 10 located between the under side of the bottom plate 5 and the upper side of the guide plate 7. During the turning motion, the shelf carriage 1 rotates around a central axis. In the refill position, the available empty space on the shelves will be located at the rear side of the shelves facing the shop attendant. By refilling the shelves from behind, the new items will be placed furthest away from the front edge of the shelves in the stack on the shelves. Thereby it is ensured that the older items in the stack on the shelves will be sold before the refilled items.

After the shop attendant has completed the refilling operation, the shelf carriage 1 is easily rotated back to the intermediate position guided by the axle 8 cooperating with the bearing 6 and assisted by the ball bearings 10. When the shelf carriage 1 is properly aligned in the intermediate position, it can easily be pushed back to the display position, wherein the linear translation is guided by the rails 13 cooperating with the wheels 9 of the guide plate 7.

In FIG. 5, an alternative realisation of the turning guide are shown. Instead of the fixed axle 8 according to the embodiment described above, an axle 8′, which is mounted on the bottom plate 5 of the shelf carriage 1, is slidably arranged in a bearing in form of a slot 6′ provided in the guide plate 7. Due to the slot 6′, the shelf carriage will be allowed to translate the length of the slot in addition to the distance travelled by the guide plate 7 during the linear translation between the display position and the intermediate position. Thereby, the shelf assembly can be constructed less space consuming than the above described embodiment having the protruding portion 15 of the guide plate 7.

Furthermore, in FIG. 5, an alternative construction of a turning bearing arrangement is shown. Instead of the ball bearings according to the above-described embodiment, two interposed plastic discs 17 are used.

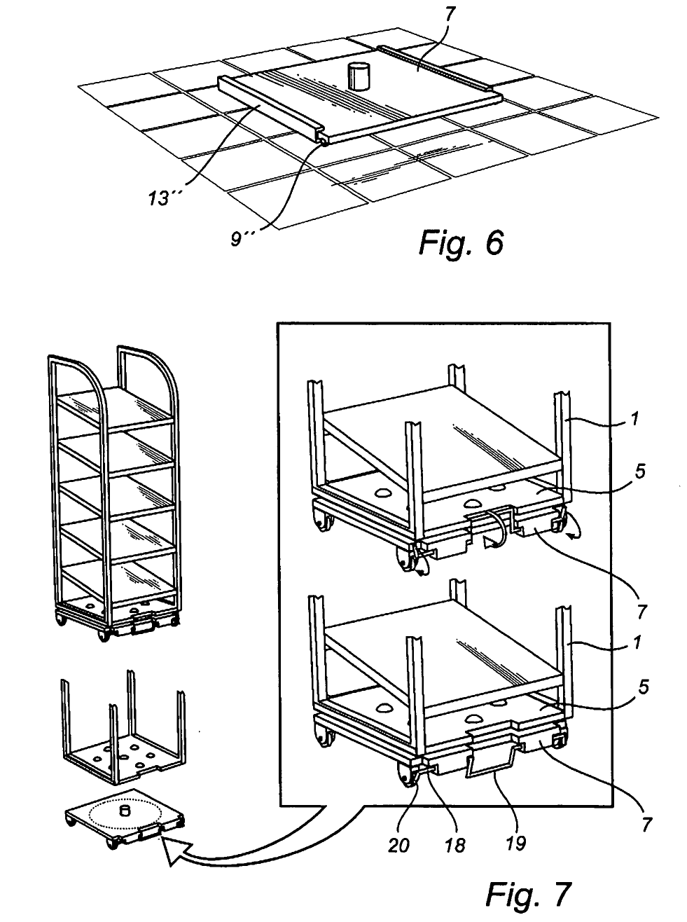

In FIG. 6, an alternative realisation of the translation guide is shown. The two side edges of the guide plate 7 are received between the flanges of a U-shaped rail 13″ respectively. The guide plate 7 is provided with two wheels 9″, one at each front corner thereof. When the shelf carriage 1 is to be moved between the display position and the intermediate position, the edges of the guide plate 7 will slide in the rails 13″ thereby guiding the linear translation of the shelf carriage 1. In the extended positions leading to the intermediate position, the two wheels 9″ will balance the weight of the shelf carriage 1 such that jamming of the edges in the rails 13″ is avoided.

In FIG. 7 locking means of the shelf assembly according to the present invention is shown. The locking means include a locking bar 18 pivotally arranged on the guide plate 7 close to the front edge thereof. The bar 18 is provided with an angled handle portion 19 arranged to fit in a recess in the front edge of the guide plate 7 and in the bottom plate 5 of the shelf carriage 1. At each end, the bar 18 has a bent break portion 20. The locking bar 18 is operable to pivot between a first and a second position as shown in FIG. 7. The locking bar 18 is biased against the first and second positions by means of springs (not shown). In the first position, the shelf carriage 1 is prevented to turn relative the guide plate 7, since the handle portion is received in the recess of the guide plate 7 and the bottom plate 5. In this position the break portions 20 do not abut against the wheels such that translation of the shelf carriage is enabled. In the second position, the shelf carriage 1 is prevented to translate, since the locking bar 18 is rotated such that the break portions 20 press against the wheels 9. In this position, the handle portion is free of the recesses such that rotation of the shelf carriage is enabled. Due to the locking means according to the invention, the manoeuvring of the shelf carriage is facilitated.

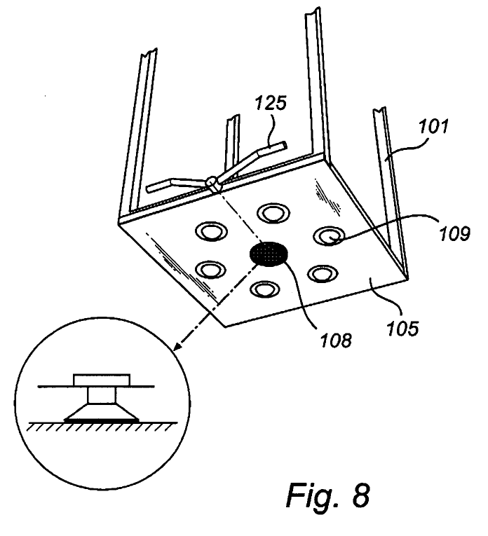

In FIG. 8, another embodiment of a self-contained in-store shelf assembly according to the invention is shown. The shelf assembly includes a shelf carriage 101 supporting a plurality of sloping shelves (not shown). In the bottom plate 105 a turning guide in the form of an extendable axle 108 is arranged. Several ball wheels 109 are provided in the bottom plate 105. The axle is operable to move between a retracted position where it is not in contact with the shop floor and an extended position where it is in engagement with the shop floor by means of a lever 125. The under side of the axle, i.e. the side that engage with the shop floor, is provide with a frictional, elastic pad for enhancing the engagement properties.

When the shelves of this shelf carriage 101 are to be refilled, a shop attendant carefully pulls the carriage 101 free of any adjacent obstacles, wherein the carriage 101 travels on the ball wheels 109. Thereafter, the axle 108 is brought to its extended position such that the axle 108 engages with the shop floor and slightly lifts the shelf carriage 101. The shelf carriage then is in the intermediate position. From the intermediate position, the shelf carriage 101 is easily turned to the refill position, wherein the turning motion is guided by the axle and facilitated by the ball wheels functioning as bearings. When the filling operation is finished, the shelf carriage is rotated back to the intermediate position, the axle 108 is retracted and the shelf carriage 101 is rolled back to the display position. Although the translation movement of the shelf carriage 101 is unguided in this embodiment, due to the guided turning motion, the intermediate position is always easily found. Since the shelf carriage 101 only has to be moved in a linear direction between the display position and the intermediate position, the shelf carriage 101 will be properly aligned in the intermediate position. Consequently, the display position is easy to find, once the shelf carriage is in the intermediate position.

Above, embodiments of the shelf assembly according to the present invention have been described. These should be seen as merely non-limiting examples. As understood by a skilled person, many modifications and alternative embodiments are possible within the scope of the invention.

It is to be noted, that for the purposes of this application, and in particular with regard to the appended claims, the word “comprising” does not exclude other elements or steps, that the word “a” or “an”, does not exclude a plurality, which per se will be apparent to a person skilled in the art.

What is claimed is:

1. A self-contained in-store merchandise shelf assembly, comprising
a shelf carriage supporting a plurality of shelves and being movably arranged between a display position, where the shelves are accessible from a front side of the shelf carriage, a refill position, where the shelves are accessible from a rear side of the shelf carriage, and an intermediate position; and
a guide arrangement cooperating with the shelf carriage, wherein
the shelf carriage is arranged for linear translation between the display position and the intermediate position and for turning motion between the intermediate position and the refill position; and wherein
the guide arrangement includes a turning guide adapted to guide the turning motion of the shelf carriage between the intermediate position and the refill position.

2. The shelf assembly according to claim 1, wherein the turning guide is adapted to guide the shelf carriage to turn around a central axis of the shelf carriage.

3. The shelf assembly according to claim 1, wherein the turning guide includes an axle and a pivotal bearing connected to the axle during the turning motion.

4. The shelf assembly according to claim 1, further including a bearing arrangement, wherein the bearing arrangement is arranged to act on a bottom plate of the shelf carriage for facilitating the turning motion of the shelf carriage.

5. The shelf assembly according to claim 1, wherein the turning guide is provided with locking means for preventing turning of the shelf carriage.

6. The shelf assembly according to claim 1, wherein the guide arrangement includes a translation guide adapted to guide the linear translation of the shelf carriage between the display position and the intermediate position.

7. The shelf assembly according to claim 6, wherein the translation guide is adapted to guide the shelf carriage along a linear path aligned normal to the front side of the shelf carriage.

8. The shelf assembly according to claim 7, wherein the shelf carriage has a depth aligned with the linear path and the translation guide is adapted to guide the shelf carriages a distance longer than the depth of the shelf carriage.

9. The shelf assembly according to any claim 6, wherein the translation guide is provided with locking means for preventing translation of the shelf carriage.

10. The shelf assembly according to any claim 6, wherein the translation guide includes a linear rail.

11. The shelf assembly according to claim 2, wherein the guide arrangement includes a translation guide adapted to guide the linear translation of the shelf carriage between the display position and the intermediate position.

12. The shelf assembly according to claim 1, further comprising a guide plate carrying the shelf carriage, wherein the turning guide is arranged on the guide plate and connected to a bottom plate of the shelf carriage.

13. The shelf assembly according to claim 12, wherein the turning guide includes an central axle which is pivotally received in a circular recess in a bottom plate of the shelf carriage.

14. The shelf assembly according to any claim 6, further comprising a guide plate carrying the shelf carriage, wherein the turning guide is arranged on the guide plate and connected to a bottom plate of the shelf carriage and wherein the translation guide is arranged to act on the guide plate.

15. The shelf assembly according to claim 14, wherein the turning guide includes an central axle arranged in a shelf facing side of the guide plate, which axle is pivotally received in a circular recess in a bottom plate of the shelf carriage and wherein the translation guide is arranged to act on the guide plate.

16. The shelf assembly according to claim 2, further including a bearing arrangement, wherein the bearing arrangement is arranged to act on a bottom plate of the shelf carriage for facilitating the turning motion of the shelf carriage.

17. The shelf assembly according to any claim 6, wherein the translation guide includes non-pivoting wheels which are attached on a bottom plate of the shelf carriage.

18. The shelf assembly according to claim 1, wherein an extendable axle is pivotally arranged in a bottom plate of the shelf carriage, and wherein the axle is operable to project out of a bottom plate of the shelf carriage and to fixedly engage with a support surface, whereby the axle provides a rotational guide for the turning motion of the shelf carriage.

19. The shelf assembly according to claim 2, wherein the turning guide includes an axle and a pivotal bearing connected to the axle during the turning motion.

20. A shelving system, comprising several shelf assemblies according to claim 1, wherein the shelf assemblies are arranged side by side.
